(19) United States
(12) Patent Application Publication
(10) Pub. No.: US 2012/0317472 A1
(43) Pub. Date: Dec. 13, 2012

(54) Creation of data extraction rules to facilitate web scraping of unstructured data from web pages

(75) Inventor: Kanstantsin Chernysh, Minsk (BY)

(73) Assignee: Profitero Ltd, Dublin (IE)

(21) Appl. No.: 13/155,284

(22) Filed: Jun. 7, 2011

(51) Int. Cl. G06F 17/30

(52) U.S. Cl. 715/234

(57) ABSTRACT

The present invention provides a method, system, and computer program to help a user without any programming knowledge create data extraction rules for collecting data from websites at scale. A user only needs to provide a web page Universal Resource Locator (URL), then mark and assign the needed data to its type. For example, on an e-commerce website, this data can be the product name, price, description, and so forth. Marking is done by highlighting the correct part of the web page. This creates a data extraction rule that describes the web template of full website and can be used thereafter for automated web scraping from all pages on a particular website.

### CROSS-REFERENCE TO RELATED APPLICATIONS

The present application is related to U.S. provisional patent application 12/819,190 entitled <<Gathering retail product information from online shop such as price, delivery cost and time, description, feedback if any, breadcrumbs and other unstructured data>>, filed on Jun. 19, 2010.

### STATEMENT REGARDING FEDERALLY SPONSORED RESEARCH OR DEVELOPMENT

Not applicable

### REFERENCE TO A SEQUENCE LISTING, A TABLE, OR A COMPUTER PROGRAM, LISTING COMPACT DISC APPENDIX

Not applicable

### BACKGROUND OF THE INVENTION

### Background

1. Every website on the Internet has a different way of structuring data due to the variety of existing web templates.

2. Existing methods for data extraction from many web pages are complicated and require high-level technical knowledge, such as proficiency with Document Object Model (DOM), Regular Expressions, scripting languages, and so forth.

3. Current solutions to facilitate data extraction from web pages are not scalable and require manual and time-consuming work from technically skilled engineers who are able to create and maintain Regular Expressions for each website.

It would be desirable, therefore, to develop a technology that allows a non-skilled computer operator to create the data extraction rules that are required to scrape unstructured data from websites at scale. This data can be used for a variety of purposes including, but not limited to, the following: shopping comparison websites, travel and hotel comparison websites, and data mining and data aggregation uses.

### BRIEF SUMMARY OF THE INVENTION

The present invention provides a method, system, and computer program to help a user without any programming knowledge to create data extraction rules for collecting data from websites at scale. A user only needs to provide a web page URL, then mark and assign the needed data to its type. For example, on an e-commerce website, this data can be the product name, price, description, and so forth. Marking is done by highlighting the correct part of the web page. This creates a data extraction rule that describes the web template and can be used thereafter for automated web scraping from all pages on a particular website.

### BRIEF DESCRIPTION OF THE SEVERAL VIEWS OF THE DRAWING

FIG. 1—Example of a web page

FIG. 2—Shows a modified copy of a web page, which is loaded from Profitero Server to an inline IFRAME that is embedded into Profitero Client

FIG. 3—Shows how the user marks required data with a mouse and then assigns it to the right data type (e.g., product title, price, description, etc.)

### OATH OR DECLARATION

Please see attached Declaration

### DETAILED DESCRIPTION OF THE INVENTION

The steps below describe the process of Regular Expression rules:

1. User loads Profitero service to a web browser (Profitero Client).

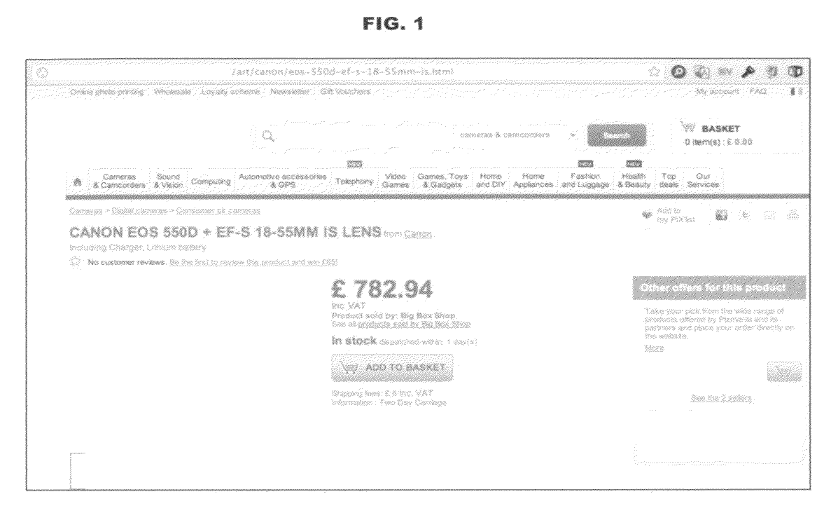

2. User provides web page URL of required web page. See FIG. 1—Example of a web page.

3. A copy of a web page is loaded to Profitero Server. Certain modifications are done in order to simplify and unify the page-marking process. Modifications to the page include:

a. <a>HTML tags are replaced with <span>tags.

b. The relative path of HTML elements on the loaded web page is modified with an absolute path.

c. References to Profitero JavaScript files are injected to the loaded web page to unify page processing in supported web browsers like Internet Explorer, Mozilla Firefox, Google Chrome, and Apple Safari.

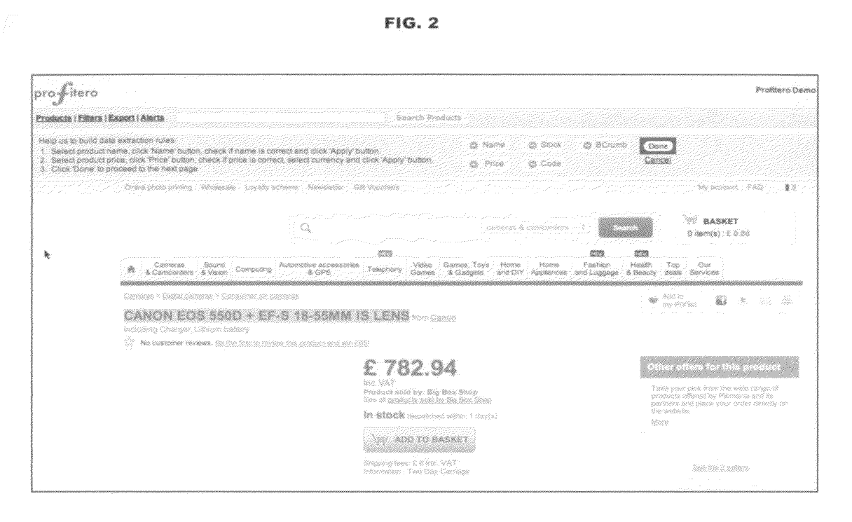

4. FIG. 2 shows a modified copy of a web page, which is loaded from Profitero Server to an inline IFRAME that is embedded into Profitero Client.

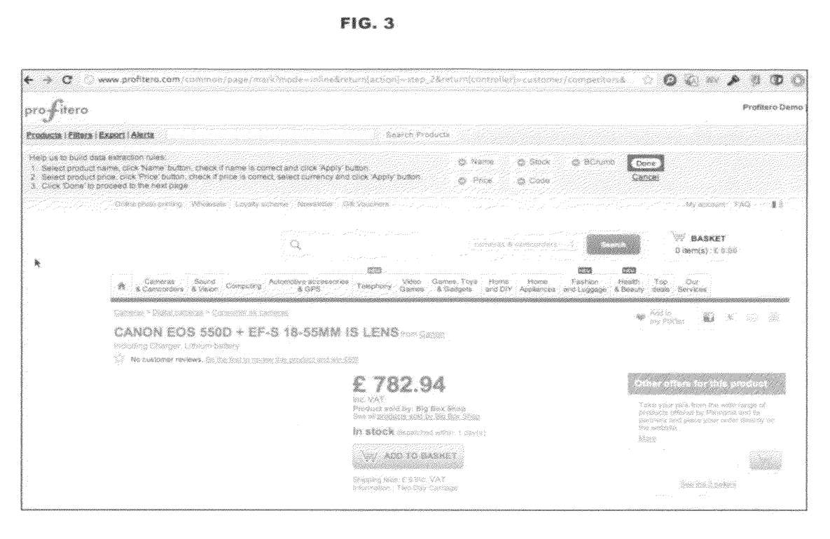

5. FIG. 3 shows how the user marks required data with a mouse and then assigns it to the right data type (e.g., product title, price, description, etc.)

NOTE: Step 3 allows the override of web browser security policy limitations, which prevent JavaScript interaction with a web page loaded from a different web server.

6. For each marked part of the web page, XPath expression and offset are calculated and then sent to Profitero Server where data extraction rules are created and assigned to a current domain name. Results of the creation of Regular Expression rules returned by the technology are:

a. XPath expression of the marked area on the modified page is retrieved.

b. Obtained XPath expression is modified to support the original web page of the product.

c. Regular Expression is built for the part of a web page that is left after XPath processing.

d. Data extraction rules that consist of the XPath and Regular Expression for the original web page.

Obtained data extraction rules are used thereafter for automated web scraping of data from all pages for particular website.

Vocabulary used:

XPath—XML Path Language, is a query language for selecting nodes from an XML document. In addition, XPath may be used to compute values (e.g., strings, numbers, or Boolean values) from the content of an XML document. XPath was defined by the World Wide Web Consortium (W3C).

Regular Expression—also referred to as regex or regexp, provide a concise and flexible means for matching strings of text, such as particular characters, words, or patterns of characters.

HTML—stands for HyperText Markup Language, is the predominant markup language for web pages.

Document Object Model (DOM)—a cross-platform and language-independent convention for representing and interacting with objects in HTML, XHTML and XML documents.

IFRAME—HTML IFRAME element allows authors to insert a frame within a block of text. Inserting an inline frame within a section of text is much like inserting an object via the OBJECT element: they both allow you to insert an HTML document in the middle of another, they may both be aligned with surrounding text, etc.

URL—a Uniform Resource Locator is a Uniform Resource Identifier (URI) that specifies where an identified resource is available and the mechanism for retrieving it.

JavaScript—an implementation of the ECMAScript language standard and is typically used to enable programmatic access to computational objects within a host environment.

What is claimed is:

1. A method of creation for data extraction rules that facilitate data collection from web pages and comprise highlighting blocks of a web page with a mouse, and creating XPath and Regular Expression rules.

2. The method, as recited in claim 1, wherein highlighting or marking of web page code is done by methods other than using a mouse.

3. The method, as recited in claim 1, wherein data extraction rules consist of methods other than XPath and Regular Expression technologies.
